(19) United States
(12) Patent Application Publication
(10) Pub. No.: US 2017/0345603 A1
(43) Pub. Date: Nov. 30, 2017

(54) TEMPERATURE-SENSITIVE PELLET TYPE THERMAL FUSE

(71) Applicants: Sung Woong YOON, Seoul (KR); DONG-YANG ELECTRONICS CO., LTD, Gwangju-si Gyeonggi-do (KR)

(72) Inventor: Sung Woong YOON, Seoul (KR)

(73) Assignees: DONG-YANG ELECTRONICS CO., LTD, Gwangju-si Gyeonggi-do (KR); Sung Woong yoon, Seoul (KR)

(21) Appl. No.: 15/417,938

(22) Filed: Jan. 27, 2017

(30) Foreign Application Priority Data
May 25, 2016 (KR) 10-2016-0063982

(51) Int. Cl. H01H 85/10; H01H 85/17; H01H 85/06

(52) U.S. Cl. CPC H01H 85/10; H01H 85/06; H01H 85/17

(57) ABSTRACT

A temperature-sensitive pellet type thermal fuse having a cylindrical metal case (10) with one end electrically connected to a first lead (L1) and a second lead (L2) installed on the other end via an insulating bushing (50). A temperature-sensitive pellet (30) on a spring (13) is in an inner space (S1) of the case (10). A switch terminal (40) has an upper surface (42) electrically connected to the second lead (L2) by an elastic force of the spring (13). A contact terminal piece (41) extends from the upper surface (42) to contact the inner wall surface (11) of the case 10. An activating member operates when the temperature-sensitive pellet (30) is reduced in height to a predetermined level or less, and releases contact between the contact terminal piece (41) and the case (10) to cut off an electrical connection between the first lead (L1) and the second lead (L2).

### BACKGROUND OF THE INVENTION

### Field of the Invention

The present invention relates to a temperature-sensitive pellet type thermal fuse, and more particularly, to a temperature-sensitive pellet type thermal fuse in which when a periphery temperature or a circuit temperature rises to a predetermined level or higher, a temperature-sensitive pellet inside a cabinet is melted so that a switch terminal elastically supported by a spring and a lead wire are attached to or detached from each other, thereby allowing a circuit to be turned on or off.

### Description of the Related Art

A thermal fuse is a component detecting an abnormal overheat of an apparatus and promptly shutting off a circuit of the apparatus, and is used in various fields such as automotive parts of a vehicle, various home appliances, portable electronic communication devices, office equipments, vehicle-loaded automotive parts, AC adapters, chargers, motors and batteries.

The thermal fuse employs, as a temperature-sensitive material, a pellet type molded with an organic material which is generally melted at a predetermined fuse activation temperature. The thermal fuse has been known by the disclosure in multiple documents including the following patent documents.

### PRIOR ART DOCUMENTS

### Patent Documents

(Patent document 1) KR10-1202434 B1

(Patent document 2) U.S. Pat. No. 5,530,417 B1

In the case of a conventional thermal fuse disclosed in the patent document 1, when a support unit is melted in an activation temperature range, a switch terminal selectively applying current to a first contact connected to a second lead wire and a first contact (an inner wall of a metal case) connected to a first lead wire is moved in a direction separating the contacts by force of a spring pressing and holding the support unit to electrically short-circuit the first and second contact points, so that a circuit is switched off.

However, in the conventional thermal fuse, the switch terminal instantly short-circuits the first and second contacts at a moment when a second spring force acting in a direction separating the switch terminal from the second contact becomes greater than a first spring force acting in a direction making the switch terminal contact the first contact, i.e. a moment when the support unit being melted is decreased to a predetermined height, so the conventional thermal fuse has a structure in which a switch operation is sensitive to the change in the height of the support unit.

Accordingly, since the structure is such that a cut-off operation is sensitive to a minute difference between acting forces of the two springs or a tiny reduction of the temperature-sensitive pellet, there has been a limitation that a malfunction of shutting off the circuit happens when an unintended shrinkage deformation occurs in the temperature-sensitive pellet in a temperature range less than a predetermined activation initiating temperature range. Since the conventional thermal fuse having the structure sensitively reacts against periphery temperature changes, there has been a limitation in that operation of the conventional thermal fuse is unstable.

Besides, since the conventional thermal fuse has the structure in which one end of the switch terminal in an outer perimeter direction thereof contacts the inner wall surface of the metal case in a line contact state, there has been a limitation in that, when the force of the spring elastically supporting the switch terminal is not evenly applied to the switch terminal, the switch terminal is deflected in any one direction to be caught by the inner wall of the case and causing malfunction by being unable to perform a sliding movement.

### SUMMARY OF THE INVENTION

Accordingly, the present invention is directed to a temperature-sensitive pellet type thermal fuse that substantially obviates one or more problems due to limitations and disadvantages of the related art, the temperature-sensitive pellet type thermal fuse having high operation reliability and accurately operating in a predetermined temperature range without malfunction owing to stable contact or separation performance between contacts.

Embodiments of the present invention provide a temperature-sensitive pellet type thermal fuse including: a cylindrical metal case, one end of which is electrically connected to a first lead while a second lead is installed to the other end to be insulated from the case by an insulating bushing; a temperature-sensitive pellet elastically supported by a spring in an inner space of the case; and a switch terminal configured to cut off electrical connection between a first lead and a second lead at the moment when the temperature-sensitive is melted and reduced in the height to a predetermined level at a predetermined fuse activation initiating temperature in accordance with rise of the periphery temperature, wherein the switch terminal is made of a thin metal sheet by forming the same, and includes an upper surface contacting a fixed contact on one end of the second lead so as to be electrically connected to each other by an elastic repulsive force of the spring without being affected by reduction deformation of the temperature-sensitive pellet, and a contact terminal piece extending from the upper surface towards a radially outer upper direction to contact an inner wall surface of the case so as to be electrically connected to each other, and wherein the temperature-sensitive pellet type thermal fuse further includes an activating member made of a non-conductive material, moving towards the contact terminal piece by force of the spring at the moment when the height of the temperature-sensitive pellet is reduced to or less than a predetermined level, and releasing contact between the contact terminal piece of the switch terminal and the case such that the first and second leads are electrically disconnected from each other.

In one aspect of the present invention, the contact terminal piece of the switch terminal may consist of a plurality of contact terminal pieces disposed on an edge of the upper surface spaced by a predetermined space from each other along the perimeter of the upper surface, wherein each of the plurality of contact terminal pieces may convexly extend from the upper surface towards a radially outer upper direction such that an outer upper end thereof contacts an inner wall surface of the case.

In one aspect of the present invention, the activating member may be made of a non-conductive material and may include: a pellet receiving groove having an opened upper side and a through-hole in a floor thereof; and a sidewall provided along the perimeter of the pellet receiving groove so as to slidingly move along an inner wall surface of the case, and slidingly contacting the inner wall surface of the case, wherein an upper end of the sidewall moves in between the inner wall surface of the case and the contact terminal piece by an elastic repulsive force of the spring and releasing contact between the contact terminal piece and the inner sidewall surface of the case, at the moment when the temperature-sensitive pellet received in the pellet receiving groove is melted and reduced in the height to a fuse activation initiating height, such that the first lead and the second lead are electrically disconnected from each other.

In one aspect of the present invention, an inner wall surface of the upper end of the sidewall of the activating member may preferably be formed as a slanted surface slanting in a lower direction towards the center of the activating member.

In one aspect of the present invention, a through-hole may be defined in the floor of the pellet receiving groove such that a melted portion of the temperature-sensitive pellet escape therethrough.

Additional advantages and features of the invention will be set forth in part in the description which follows and in part will become apparent to those having ordinary skill in the art upon examination of the following or may be learned from practice of the invention.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is an exploded perspective view schematically illustrating an overall configuration of a temperature-sensitive pellet type thermal fuse according to an embodiment of the present invention;

FIG. 2 is a cross-sectional assembly view in a longitudinal direction of a temperature-sensitive pellet type thermal fuse according to an embodiment of the present invention illustrating a state when temperatures inside and outside a case correspond to a switched on state;

FIG. 3 is a cross-sectional assembly view in a longitudinal direction illustrating a state right before an activating member releases contact between an inner wall surface of the case and a switch terminal;

FIG. 4 is a cross-sectional assembly view in a longitudinal direction illustrating a state after the contact between the inner sidewall surface of the case and the switch terminal is released by the activating member;

FIG. 5 is an enlarged detailed view of “X” section of FIG. 3; and

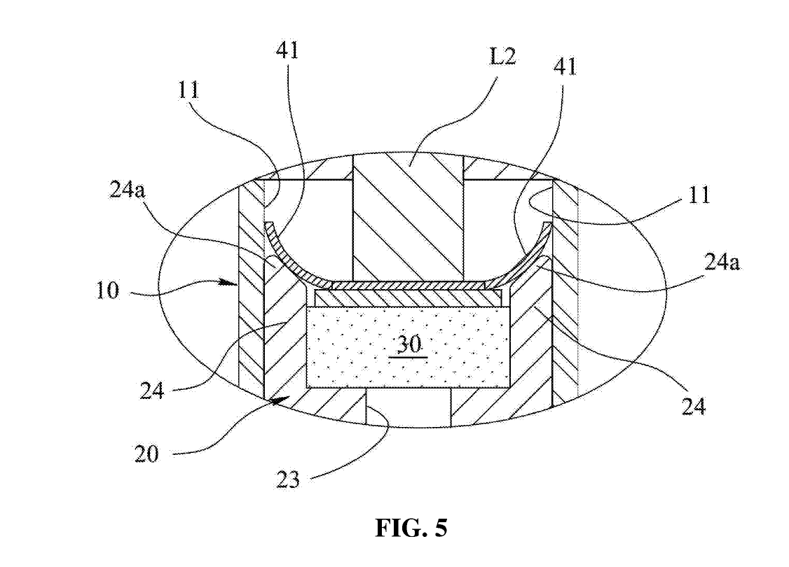

FIG. 6 is an enlarged detailed view of “Y” section of FIG. 4.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts. Hereinafter, a temperature-sensitive pellet type thermal fuse according to embodiments of the present invention will be described in detail with reference to accompanying drawings.

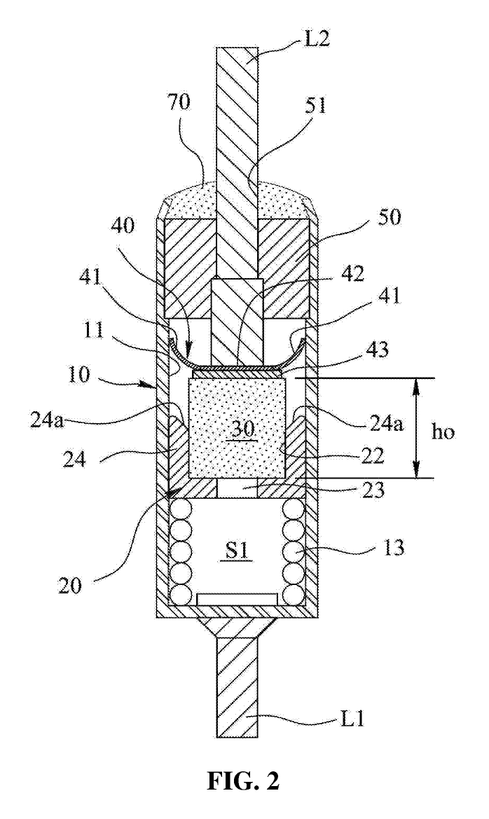

FIG. 2 is a cross-sectional assembly view of the temperature-sensitive pellet type thermal fuse according to an embodiment of the present invention, and illustrating a placement state between components in a switched on state in which a first lead L1 and a second lead L2 are electrically connected to each other. Hereinafter, for the convenience of explanation, an opened upper end side of a case 10 of FIG. 2 is referred to as “an upper portion”, a floor portion thereof is referred to as “a lower portion”, a direction towards the opened upper end side thereof is referred to as “an upper direction”, a direction opposite thereto is referred to as “a lower direction”, and “a left side” and “a right side” are respectively referred to as a left side and a right when viewed from the front of FIG. 2.

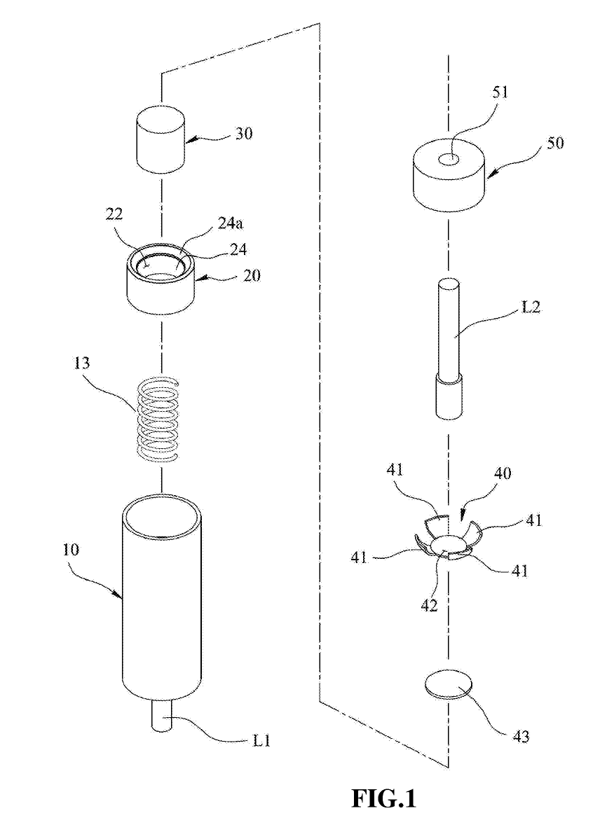

As illustrated in FIGS. 1 and 2, the temperature-sensitive pellet type thermal fuse according to an embodiment of the present invention includes: a metal case 10 having an open end at one side and a first lead L1 is connected to a bottom wall at the opposite side; a temperature-sensitive pellet 30; an activating member 20 having the temperature-sensitive 30 placed thereon, slidingly installed inside the case 10, and biased towards the first lead L1 by a spring 13; a second lead L2 provided to pass through a through-hole 51 of an insulating bushing 50 fixed to an upper portion of the case 10 to extend in the inside of the case 10, and having a fixed contact on one end in the inside of the case 10; and a switch terminal 40 installed such that an upper surface 42 thereof contacts a lower end of the second lead L2 extended in the inside of the case 10, and a lower surface thereof contacts an upper surface of the temperature-sensitive pellet 30 placed on the activating member 20, and having a contact terminal piece 41 provided on the edge thereof to contact an inner wall surface 11 of the case 10.

As illustrated in FIG. 2, the second lead L2 is disposed to pass through the through-hole 51 of the insulating bushing 50 inserted in the upper portion of the case 10 so as to be insulated from the case 10, a lower end thereof extends under a lower end of the insulating bushing 50, and an upper end thereof is sealed and fixed with a sealing material 70 in a state in which the second lead L2 passes through the insulating bushing 50 and extends to the outside.

The activating member 20 receives and supports the temperature-sensitive pellet 30 molded to have a predetermined height h0 and not yet melted in a pellet receiving groove 22 surrounded by the sidewall 24, and an outer surface of the sidewall 24 is slidingly guided on the inner wall surface 11 of the case 10. An upper end 24a of the sidewall 24 is slanted from an outer surface of the upper end in a lower direction towards the pellet receiving groove 22 so as to gradually pressurize an outer surface of the contact terminal piece 41 when moving in a space between the contact terminal piece 41 of the switch terminal 40 and the inner wall surface 11 of the case 10.

The activating member 20 is elastically supported by the spring 13 compressedly installed between a lower surface thereof and the lower portion the case 10. The switch terminal 40 is independently placed on the upper surface of the temperature-sensitive pellet 30 received in the pellet receiving groove 22, or is placed on a base plate 43 intervening therebetween.

As described above, the switch terminal 40 placed on the upper surface of the temperature-sensitive pellet 30 is formed by bending a thin metal sheet, and has the upper surface 42 contacting one end of the second lead L2 in the center thereof so as to be electrically connected to each other, and a plurality of contact terminal pieces 41 slantingly extending from the edge of the upper surface 42 towards a radially outer upper direction such that an outer surface thereof is electrically contacting the inner wall 11 of the case.

Meanwhile, it is also included in the present invention that one end of the second lead L2 is fixed to the upper surface 42 of the switch terminal 40 by a coupling means such as riveting or soldering. In this case, a stable contact between the switch terminal 40 and the second lead L2 may be achieved, so malfunction caused by an unstable contact therebetween may be prevented.

As illustrated in FIG. 2, in the switch terminal 40, the upper surface 42 contacts a fixed contact terminal of the second lead L2 by an elastic repulsive force of the spring 13 transmitted through the activating member 20 when the temperature-sensitive pellet 30 is at the height h0 of the initial state, and the plurality of contact terminal pieces 41 disposed spaced by a predetermined space from each other along the perimeter of the upper surface 42 contact the inner wall 11 of the case 10.

The temperature-sensitive pellet 30 is made by compressing and molding a non-conductive organic material in a pellet shape. As illustrated in FIG. 2, the temperature-sensitive pellet 30 has the height h0, and is installed to be placed on a floor inside the pellet receiving groove 22. The temperature-sensitive pellet 30 is melted when the periphery temperature of the case 10 is at a predetermined preset fuse activation initiating temperature (an activation temperature at which a thermal fuse cuts off a circuit) or higher, and the height thereof is reduced from h0 to h1.

As illustrated in FIG. 2, in the activating member 20, a hole 23 is defined in the floor of the pellet receiving groove receiving the temperature-sensitive pellet 30, so when the temperature-sensitive pellet 30 inside the pellet receiving groove 22 is melted, a melted portion 30a is discharged through the hole 23 in the lower portion of the case 10, i.e. in a lower space of the case 10 in which the spring 13 is installed such that the melted portion 30a does not interrupt sliding movement of the sidewall 24 of the activating member 20.

Meanwhile, the base plate 43 may be installed between the lower surface of the switch terminal 40 and the upper end surface of the temperature-sensitive pellet 30. When the base plate 43 is installed, the switch terminal 40 may be stably supported even though the upper end surface of the temperature-sensitive pellet 30 is unevenly melted.

Hereinafter, an operating mechanism of the thermal fuse according to an embodiment of the present invention will be described with reference to the accompanying drawings.

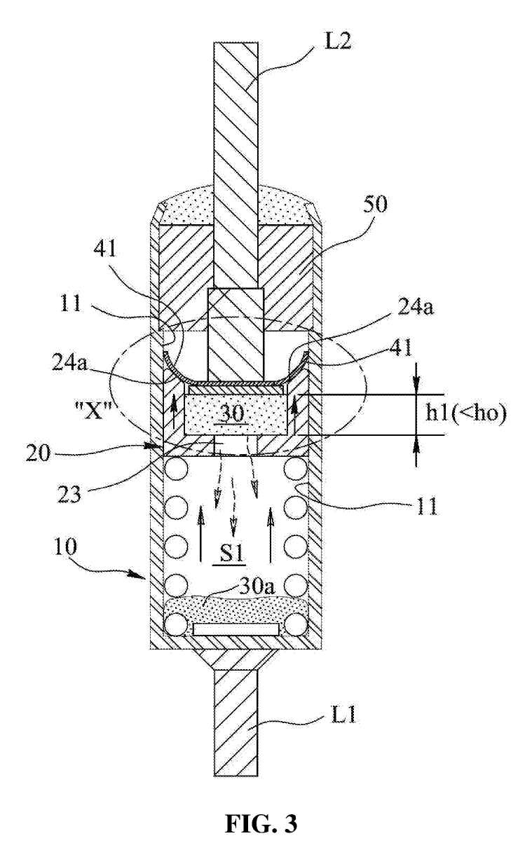

Normal State: Switched on State (FIGS. 2 and 3)

As illustrated in FIG. 2, if the periphery temperature of the case 10 is equal to or less than a predetermined fuse activation initiating temperature, the temperature-sensitive pellet 30 is not melted, so the temperature-sensitive pellet 30 is not changed in the height. Thus, in the switch terminal 40, the upper surface 42 thereof contacts the second lead L2 by the force of the spring 13, and at the same time, the contact terminal piece 41 contacts the inner wall surface 11 of the case 10, so the switch terminal 40 is electrically connected to the first lead L1, ultimately, and the circuit maintains a switched on state.

Further, as illustrated in FIG. 3, if the temperature-sensitive pellet 30 is partially melted under a temperature equal to or less than the predetermined preset fuse activation initiating temperature, and the height of the temperature-sensitive pellet 30 is equal to or greater than a preset fuse activation initiating height h1, as in the aforementioned case of FIG. 2, the switch terminal 40 remains in contact with the second lead L2 through the upper surface 42 thereof by the force of the spring 13, and the at the same time, the contact terminal piece 41 also remains in contact with the inner wall surface 11 of the case 10 so as to be electrically connected with the first lead L1, so the circuit maintains a switched on state.

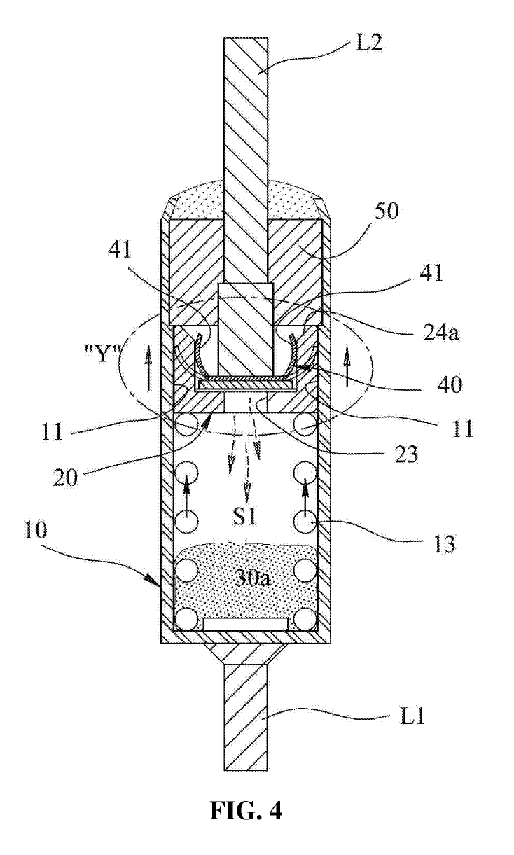

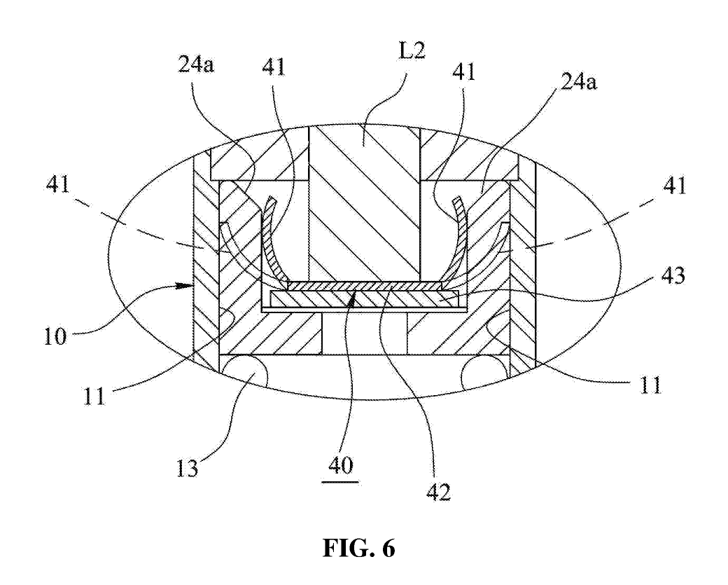

Switched Off State (FIGS. 4 and 6)

As the periphery temperature rises, the temperature-sensitive pellet 30 is melted and reduced in the height, and at the same time, the activating member 20 supporting the temperature-sensitive pellet 30 receives the elastic repulsive force of the spring 17 and moves toward the switch terminal 40, after a moment when the height of the temperature-sensitive pellet 30 is reduced to the fuse activation initiating height h1 as shown in FIG. 3, the upper end 24a of the sidewall 24 of the activating member 20 moves in between the inner wall surface 11 of the case 10 and the contact terminal piece 41 of the switch terminal 40 and releases the contact between the contact terminal piece 41 of the switch terminal 40 and the inner wall surface 11 of the case 10, as shown in FIGS. 4 and 6.

Accordingly, the first and second leads L1 and L2 connected to the case 10 are electrically disconnected from each other, thereby cutting off the circuit.

As above, since the activating member 20 releases contact between the switch terminal and the case while performing a linear sliding movement as the temperature-sensitive pellet 30 is melted and reduced in the height (i.e. by deformation degree of the temperature-sensitive pellet due to temperature rise), a switch off operation is accurately performed without malfunction, and a thermal fuse having high safety may be provided.

Further, even when a phenomenon occurs in which the switch terminal 40 tilts with respect to a central axis direction of the case inside the case 10, since the contact terminal piece stably contacts the inner wall surface of the case, it is possible to fundamentally prevent an undesired deformation of the temperature-sensitive pellet or a phenomenon in which the switch terminal tilts to be biased in any one direction and caught by the inner wall of the case due to an uneven force of the spring arising from the deformation of the temperature-sensitive pellet.

According to the configuration set forth herein, since the activating member releases contact between the case and the switch terminal while performing a linear sliding movement as the temperature-sensitive pellet is melted, the switch operation is accurately performed within a predetermined temperature range without malfunction.

Also, the switching operation is performed only when the temperature-sensitive pellet is melted and deformed by a predetermined amount by rise of the periphery temperature without being directly affected by deformation of the temperature-sensitive pellet caused by unexpected factors such as external vibration or impact, thereby ensuring high operation reliability.

What is claimed is:

1. A temperature-sensitive pellet type thermal fuse comprising:
a cylindrical metal case (10), one end of which is electrically connected to a first lead (L1) while a second lead (L2) is installed to the other end to be insulated from the case (10) by an insulating bushing (50);
a temperature-sensitive pellet (30) elastically supported by a spring (13) in an inner space (S1) of the case (10);
a switch terminal (40) made by forming a thin metal sheet, and comprising an upper surface (42) contacting a fixed contact on one end of the second lead (L2) so as to be electrically connected to each other, and a plurality of contact terminal pieces (41) disposed on an edge of the upper surface (42) spaced by a predetermined space from each other along the perimeter of the upper surface (42), wherein each of the plurality of the contact terminal pieces (41) convexly extends from the upper surface (42) towards a radially outer upper direction to contact an inner wall surface (11) of the case (10) so as to be electrically connected to each other; and
an activating member (20) made of a non-conductive material and comprising a pellet receiving groove (22) having an opened upper side and a through-hole (23) in a floor thereof, and a sidewall (24) provided along the perimeter of the pellet receiving groove (22) so as to slidingly move along an inner wall surface (11) of the case (10), and slidingly contacting the inner wall surface (11) of the case (10), wherein the activating member (20) moves in between the inner wall surface (11) of the case (10) and the contact terminal pieces (41) and releases contact between the contact terminal piece (41) and the inner wall surface (11) of the case (10), at the moment when the temperature-sensitive pellet (30) received in the pellet receiving groove (22) is melted and reduced in the height to a fuse activation initiating height (h1), such that the first lead (L1) and the second lead (L2) are electrically disconnected from each other, and wherein an inner surface of an upper end (24a) of the sidewall (24) of the activating member (20) is formed as a slated surface slanting in a lower direction towards the center of the activating member (20).
